(19) United States
(12) Patent Application Publication
(10) Pub. No.: US 2022/0136175 A1
(43) Pub. Date: May 5, 2022

(54) PRODUCTION OF CORRUGATED PAPERBOARDS AND CARDBOARDS COMPRISING CHEMICALLY TREATED PAPER

(71) Applicant: Borregaard AS, Sarpsborg (NO)

(72) Inventors: Synnøve Holtan, Sarpsborg (NO); Steen Jacobsen, Sarpsborg (NO); Katérina Liapis, Sarpsborg (NO); Yasuhide Numata, Osaka (JP); Yasuhiro Yamamori, Osaka (JP); Hironori Tanaka, Osaka (JP); Jan Berg, Sarpsborg (NO); Odd Henry Pedersen, Sarpsborg (NO)

(21) Appl. No.: 17/429,583

(22) PCT Filed: Feb. 19, 2020
(86) PCT No.: PCT/EP20/54347

§ 371 Date: Aug. 9, 2021

(30) Foreign Application Priority Data
Feb. 20, 2019 (EP) 19158379.8

(51) Int. Cl. D21H 27/40; B31F 1/28; D21H 19/54; C09J 103/02; B31F 5/04; D21H 19/52; C09J 101/02

(52) U.S. Cl. CPC D21H 27/40; B31F 1/2809; B31F 1/2818; D21H 19/54; C09J 2401/006; B31F 5/04; D21H 19/52; C09J 101/02; C09J 2403/00; C09J 103/02

(57) ABSTRACT

The present invention relates to a high speed process for making corrugated paperboards and cardboards, said paperboards and cardboards comprising chemically treated paper, and said process using a starch-based adhesive that comprises microfibrillated cellulose. The present invention also relates to corrugated paperboards and cardboards comprising said starch-based adhesive composition comprising microfibrillated cellulose and said chemically treated paper.

### FIELD OF THE INVENTION

The present invention relates to a high speed process for making corrugated paperboards and cardboards, said paperboards and cardboards comprising chemically treated paper, and said process using a starch-based adhesive that comprises microfibrillated cellulose. The present invention also relates to corrugated paperboards and cardboards comprising said starch-based adhesive composition comprising microfibrillated cellulose and said chemically treated paper.

### BACKGROUND OF THE INVENTION

Starch-based adhesives (or adhesives based on starch derivatives) are generally known, in particular in the paper industries.

For example, U.S. Pat. No. 3,434,901 discloses a suspension of raw or uncooked starch in a suitable liquid carrier. For example, raw corn, tapioca or potato starch, comprising up to 40% by weight of the adhesive, suspended in a carrier consisting of water and smaller amounts of cooked starch, borax and caustic soda would constitute a typical raw starch formulation. In this state, the starch has limited or no adhesive qualities. However, at a certain temperature, dependent upon the type of starch utilized and the kind and amount of additives dissolved in the carrier, the starch granules will absorb the liquid of suspension available and swell, causing gelation of the suspension. In this state the starch has superior adhesion abilities and will form a bond between many substrates, including paper.

U.S. Pat. Nos. 2,884,389 and 2,886,541 disclose that a starch based corrugating adhesive can be produced that is highly water resistant or waterproof in nature. These two patents disclose reacting phenolic compounds, such as resorcinol, with an aldehyde, such as formaldehyde, under alkaline conditions in the presence of pasted starch so as to form in situ a phenolic-aldehyde resin-starch reaction product. The teaching of these two patents has been employed on a commercial scale in the production of highly water-resistant to waterproof corrugated and laminated paperboard products. U.S. Pat. No. 3,294,716 teaches the addition of borax to the general phenol-aldehyde-starch formula, along with the reduction of concentration of the phenolic compound, to reduce costs and increase machine speed rates for particular corrugated paperboard products that do not require a high degree of water resistance.

CN 105 542 676 discloses the use of oxidized nanocellulose cellulose as a matrix for starch-based adhesives. The compositions generally comprise 100 parts of an oxidized nanocellulose pulp having an oxidation rate of 5-30%, 10-40 parts of starch, 2-5 parts of an oxidizing agent, 0.1-2 parts of a stabilizer, 0.1-2 parts of a preservative, and 0.1-2 parts of emulsified paraffin.

However, presently used starch-based adhesive compositions are limited in regard to the processing of specialty papers, for example chemically treated papers, in particular impregnated or surface coated papers that are increasingly used for high end cardboards.

In particular, initial tack and adhesion properties and processing speed on a corrugated cardboard production line generally need to be improved.

### SUMMARY OF THE PRESENT INVENTION

Based on the problems outlined above and in view of the prior art, it is an object of the present invention to provide a process for making corrugated paperboards or cardboards, which process may run at increased speed and/or efficiency over processes known from the art and, in particular, provide a process and a corrugated board product that avoids or minimizes any of the disadvantages outlined above.

In accordance with a first aspect of the present invention, this problem and others is/are solved by a process for making corrugated paperboards or cardboards, said process comprising at least the following steps:

providing a starch-based adhesive composition, said composition comprising:
at least one starch and/or at least one starch derivative, in an amount of 5% w/w to 60% w/w, dry matter, of the overall adhesive composition;
at least one solvent, said solvent preferably comprising or consisting of water, in an amount of 30% w/w to 95% w/w of the overall adhesive composition;
microfibrillated cellulose in an amount of 0.001% w/w to 10% w/w, dry matter, of the overall adhesive composition, preferably of 0.01% w/w to 5% w/w, dry matter, of the overall adhesive composition;
providing fluting paper and liner paper for corrugated paperboard or cardboard; wherein said paper for the flutes or for the liners, or both, is or has/have been at least partly chemically treated,
applying said starch-based adhesive to at least a part of the tips of the flutes of a corrugated piece of paper, on at least one side, preferably on both sides and:
in a corrugator, applying at least one liner onto said corrugated piece of paper, preferably applying a further liner on the other side of the corrugated piece of paper, and
preparing a single, double, triple or further multiple wall cardboard, preferably in a continuous process.

In embodiments of the present invention, the at least partly chemically treated paper has been or is subjected to impregnation or surface coating or treatment, surface or internal sizing, wet-end treatment, dry-end treatment, size or film pressing or any combination thereof, with at least one chemical composition that may comprise water, or any other solvent, but that comprises at least one compound other than water or solvent.

In embodiments of the present invention, the at least partly treated paper has been or is subjected to impregnation or surface coating or treatment, surface or internal sizing, wet-end treatment, or any combination thereof, wherein said surface coating or treatment, surface or internal sizing, wet-end treatment, or any combination thereof comprises at least one of the following: means to control the pH, means to improve retention, means to fix additives onto fibers, means to control penetration of liquids, means to improve burst and tensile strength, means to improve acid wet strength, means to improve optical and printing properties, means to improve or adjust a desired color, means to improve drainage and sheet formation, means to improve water retention or water removal, means to improve (optical) brightness, means to prevent deposition, means to control or inhibit growth or organism, means to control corrosion, means to affect surface tension (contact angle), (mineral) fillers, in particular kaolin, calcium carbonate, silicates, titanium dioxide, dyestuffs.

In embodiments of the present invention, the at least partly chemically treated paper has been or is subjected to at least one chemical selected from pigments, (mineral) fillers, polyvalent cations, in particular Al³⁺ and Fe³⁺, natural or chemically modified starches (cationic starches, anionic starches, oxidized starches, dextrin), natural gums or chemically modified gums, cellulose derivatives (such as carboxymethyl cellulose, hydroxyethyl cellulose, ethyl hydroxyethyl cellulose, methyl cellulose or hemicelluloses), native or chemically or physically modified microfibrillated cellulose, microcrystalline cellulose, synthetic polymers, in particular phenols, alcohols (such as polyvinyl alcohol), acetates (such as polyvinyl acetate), polyamines, polyacrylamides, polyacrylic acids and compounds, polyacylic compounds, formaldehyde containing resins or polymers, such as urea- or melamine-formaldehyde, polyamides, latices or naturally occurring polymers such as resins, in particular wood pitch or resin, waxes, rosins etc.

In preferred embodiments of the present invention the at least one compound other than water or solvent is a polymer composition.

In further preferred embodiments of the present invention the polymer composition is or comprises polyacrylamide, preferably anionic, cationic or amphoteric polymers and/or copolymers of acrylamide.

In embodiments of the present invention, the at least partly chemically treated paper has been or is subjected to at least one chemical selected from: means to improve dry strength, in particular water-soluble polyelectrolytes, dry strength resins, anionic or cationic copolymers of acrylamide, acrylamide polymers, including amphoteric products (with both anionic and cationic groups), linear or branched, low or high molecular weight polyacrylamides, synthetic dry-strength agents, synthetic dry-strength agents with molecular mass values below one million grams per mole, starch, starch derivatives or cationic starch, native or chemically or physically modified microfibrillated cellulose, microcrystalline cellulose, derivatives of natural products including carboxymethyl cellulose and guar gum derivative, pigments such as clay, calcium carbonate, titanium dioxide or plastic pigments, dispersants such as polyphosphates, lignins or lignin derivatives such as lignosulfonates- or silicates, binders such as water soluble adhesives (glues, gums, casein, starches, soya protein) and polymer emulsions (latexes, acrylics, polyvinyl acetate), insolubilizers such as formaldehyde donors, glyoxal and latices, plasticizers such as stearates, wax emulsions and azite, rheology control agents such as natural polymers, cellulose derivatives and synthetic polymers, preservatives such as formaldehyde and beta-naphthol, defoamers (proprietary agents) and dyes such as lakes, direct or acid dyes.

In embodiments of the present invention, the weight of the paper used as a liner is from 25 to 600 g/m², preferably from 40 to 400 g/m², more preferably from 100 to 350 g/m² and/or the weight of the paper used as a flute is from 25 to 500 g/m², preferably from 40 to 300 g/m², more preferably from 100 to 260 g/m².

In embodiments of the present invention, the chemically treated paper is characterized by a comparatively low surface roughness, in particular as measured according to the ISO 8791-2: 2013, i.e. the Bendtsen air flow method, wherein said surface roughness is below 1000 ml/min, preferably below 500 ml/min, preferably below 250 ml/min, further preferably below 200 ml/min, further preferably below 100 ml/min, further preferably below 50 or 25 ml/min.

In embodiments of the present invention, the chemically treated paper is characterized by a comparatively high air resistance/low air permeation, in particular as measured according to the ISO 5636-5, i.e. the Gurley method, wherein said air resistance in the paper is measured as sec/100 ml and can be related to penetration capability of the adhesive, wherein said air resistance is above 20 sec/100 ml, preferably above 50 sec/100 ml, further preferably above 100 sec/100 ml, further preferably above 150 sec/100 ml, further preferably above 200 sec/100 ml, or further preferably above 250 or 300 sec/100 ml.

In embodiments of the present invention, the paper used as a liner is selected from coated, white top, white, brown or pre-print; originating from virgin fibers, in particular Kraft liners, and/or from recycled fibres.

In embodiments of the present invention, the paper used as fluting may be semi-chemical, recycled or recycled reinforced papers.

In a preferred embodiment the paper used as fluting is recycled or recycled coated or recycled impregnated or recycled sized (with or without starch treatment) papers, or recycled papers with improved barrier properties, such as improved water resistance or recycled reinforced paper, in particular recycled paper reinforced with strengthening agents, in particular strengthening agents comprising polymer compositions, preferably polyacrylamide and/or starch compositions.

In embodiments of the present invention, the chemically treated recycled fluting paper is characterized by a comparatively high air resistance/low air permeability, in particular as measured according to the ISO 5636-5, i.e. the Gurley method, wherein said air resistance in the paper is measured as sec/100 ml and can be related to penetration capability of the adhesive, wherein said air resistance is above 20 sec/100 ml, preferably above 30 sec/100 ml, further preferably above 40 sec/100 ml, further preferably above 50 sec/100 ml, further preferably above 80 sec/100 ml, or further preferably above 100 or 150 sec/100 ml.

In embodiments of the invention, the paper used as fluting is a (high performance) semi-chemical paper characterized by a comparatively high air resistance/low air permeability, in particular as measured according to the ISO 5636-5, i.e. the Gurley method, wherein said air resistance in the paper is measured as sec/100 ml and can be related to penetration capability of the adhesive, wherein said air resistance is above 20 sec/100 ml, preferably above 30 sec/100 ml, further preferably above 40 sec/100 ml, further preferably above 50 sec/100 ml, further preferably above 80 sec/100 ml, or further preferably above 100 or 150 sec/100 ml.

Semi-chemical fluting is a paper comprising only one ply, whereas a Kraft liner may be a one or two or a three (or more) ply product.

The one, two or three layers may comprise mixtures of virgin fiber and recycled fiber. The layers may be bleached (typically white top for printing possibilities). The different layers may be added together, out of the headbox (pulp conc. ca 1%), or just before the press section (pulp conc. ca 20%).

Test liners typically comprise one ply of paper but can also be in 2 plies. Depending on the type of test liner the fiber composition of mixes of types of recovered paper can be different in each layer. In general, a better grade of mix is used for the upper layer for reasons of appearance and strength. In order to increase its strength the liner may be subjected to a surface treatment in a size press. This may involve, for example, the application of a starch solution to one or both sides of the liner. The top ply of the Test liner is preferably given an even, mostly brown colour by colouring the mass or by means of the size press treatment. The addition of special additives (in the mass or by means of the size press) makes it possible to produce liners with special properties such as extra water-repellent, low germ and anti-corrosion grades.

Surface treatment of recycled/recovered paper used as corrugated board materials is often implemented by size press or film press. Essentially a size press comprises two revolving rubber covered rolls, pressed together, through which the paper web passes. In the nip formed between the rolls, the surface treatment solution is applied, e.g. a starch solution. The paper absorbs some of this solution, is pressed between two rolls and proceeds into the “after dryer” section of the paper machine in order to evaporate excess water. Other chemicals, such as polyacrylamide can also be added in the size press to achieve higher strength of the papers. In a film press the amount of, e.g., starch and other dry materials can generally be better controlled.

To further control the retention, drainage and strength of fluting papers, a selection of chemicals are used, alone or in combinations in the wet-end of paper making. This application of chemicals can be referred to as an impregnation or surface coating of the papers. One of the more important chemical additives is high molecular weight polyacrylamide, which aids at achieving adequate retention and drainage on fine papers. Highly cationic polymers e.g. polyethylene imines may also be used as retention/drainage aid on fluting papers.

However, the application of chemical compounds to control retention, drainage and strength of the flute and liner papers as used to make corrugated boards, may interfere with paper impregnation by the adhesive, which tends to decrease the adhesive properties such as tack and initial bond strength, in particular. Therefore, it is generally required to slow down the board production line.

Surprisingly, the inventors have found that by the addition of comparatively small amounts of microfibrillated cellulose to starch adhesive, corrugated boards comprising chemically treated papers, e.g. polyacrylamide treated fluting papers, can be run at higher speeds. In fact, the production line can now be run at speeds up to 250 m/min on these chemically treated fluting papers. Higher running speeds increase the capacity, which is economically beneficial.

Without being bound by theory, the application of microfibrillated cellulose to the starch adhesive in the production of corrugated boards comprising chemically treated papers, is believed to improve the wetting and flow of the adhesive onto the surface, increasing the (cavity) penetration of the glue onto these specialty papers. This effect, in particular compared to a borax (only) reference adhesive, allows for higher speed production of corrugated boards comprising chemically treated papers. A proper balance between wetting and penetration of the glue inside the paper is preferably achieved to ensure improved bonding between the papers.

According to a further aspect, the present invention also relates to corrugated paperboards or cardboards having at least one flute and at least one liner, wherein at least one of these (or both) has or have been at least partly chemically treated, said paperboards or cardboards comprising the starch-based adhesive composition comprising microfibrillated cellulose as described above and herein.

In embodiments, the amount of microfibrillated cellulose in the adhesive composition is from 0.01% w/w, relative to the overall weight of the composition to 8% w/w, preferably from 0.01% w/w to 5% w/w, further preferably from 0.01% w/w to 2% w/w, further preferably from 0.01% w/w to 0.5%, further preferably from 0.01% w/w to 0.15% w/w or from 0.015% w/w to 0.3% w/w, or the amount of microfibrillated cellulose is from 0.003% w/w to 16% w/w, preferably 0.02% w/w to 16% w/w, preferably 0.04% w/w to 4% w/w, preferably 0.04% w/w to 2% w/w, further preferably 0.04% w/w to 1.4% w/w, even further preferably 0.04% w/w to 0.6% w/w, as measured relative to the overall amount of starch in the adhesive composition.

In embodiments of the present invention, the amount of microfibrillated cellulose in the adhesive composition is from 0.015% dry matter, relative to the overall weight of the composition to 1%, further preferably from 0.02% to 0.1%, and/or the amount of microfibrillated cellulose is from 0.003% w/w 22% w/w, preferably from 0.01% w/w to 20% w/w, or from 0.02% w/w to 4% w/w or from 0.04% w/w to 1% w/w, as measured relative to the overall amount of starch in the adhesive composition.

The inventors have surprisingly found that comparatively low amounts of MFC can be used in starch-based adhesives, for example 10% w/w or less, or 5% w/w or less, while still achieving the advantages that MFC has as an additive, which advantages are described throughout the disclosure.

Generally, the skilled person wants to keep the amount of any additive that may be needed as low as possible. Without wishing to be bound by theory, it is believed that the effect of using small amounts of MFC as an additive to significantly affect the properties of the overall adhesive composition is due to the network-forming (cross-linking) capabilities of MFC. Generally, if the amount of MFC is chosen too low, for example below 0.001% w/w, the cross-linked network may not be strong enough. Or, at even lower amounts, the amount of fibrils may be too low to form a continuous network. On the other hand, if too much MFC is present, for example more than 10% w/w, then the viscosity may be too high and the overall composition may be difficult to process.

In accordance with the present invention, the term “dry matter” (also: “solids content”) refers to the amount of microfibrillated cellulose (and/or starch) remaining if all the solvent (typically water) is removed. The amount is then calculated as weight % relative to the overall weight of the adhesive composition (including solvent, starch and other adjuvants, if present).

In embodiments of the invention, the amount of solvent is from 30% to 80%, further preferably from 40% to 75% w/w or 55% w/w to 70%, w/w, or from 60% w/w to 80%, w/w, relative to the overall adhesive composition.

In embodiments of the invention, the amount of starch and/or starch derivative is from 10% to 50%, dry matter, further preferably from 15% to 35%, w/w, relative to the overall adhesive composition.

In embodiments of the invention, the overall amount of starch in said composition is from 15% w/w to 50% w/w, preferably from 25% w/w to 48% w/w or from 22% w/w to 35% w/w, more preferably from 30% w/w to 46% w/w and further preferably from 35% w/w to 45% w/w, of the overall adhesive composition.

The inventors have surprisingly found that a higher amount of starch can be used in a starch-based adhesive composition that also comprises MFC, compared to the otherwise same composition that does not comprise MFC. Without wishing to be bound by theory, it is believed that this possibility to incorporate more starch into the overall composition is due to the thixotropic (shear thinning) capabilities of MFC. During storage, MFC stabilizes the dispersion, which maintains stable (high) viscosity. In processing (e.g. applying the adhesive on flute and/or liner of a cardboard), the shear thinning properties of MFC allow to spread and apply the overall composition even if the same comprises a large amount of starch that would otherwise make continuous processing difficult.

In embodiments of the invention, the at least one starch is a native starch, or a chemically or a physically modified starch, or a mixture thereof.

In accordance with the present invention, the starch-based adhesive may comprise (but does not have to comprise) borax.

In accordance with the present invention, although “borax” and boric acid are generally understood to not be the same compound; [borax is a salt of boric acid, i.e. borax is sodium (tetra)borate, while boric acid is hydrogen borate], whenever the term “borax” is used, the term refers to boric acid and its alkaline metal salts. In particular, a number of related minerals or chemical compounds that differ primarily in their crystal water content are referred to as “borax” and are included within the scope of the present invention, in particular the decahydrate. Commercially sold borax is typically partially dehydrated. In accordance with the present invention the term “borax” also encompasses boric acid or borax derivatives, e.g boric acid or borax that has been chemically or physically modified.

In embodiments MFC can be used advantageously to replace parts or all of the borax as typically used as an additive in starch based adhesive.

Unless explicitly stated otherwise, all ranges or values given for the amount of any component in the compositions of the present invention are meant to be given in weight % of the component relative to the overall weight of the adhesive composition (“w/w”).

The adhesive compositions according to the present inventions may comprise other components, in particular caustic soda, borax and/or at least one preservative.

In accordance with the present invention, an “adhesive” is understood to be a material that is applied to the surfaces of articles to join these surfaces permanently by an adhesive bonding process. An adhesive is a substance capable of forming bonds to each of the two parts, wherein the final object consists of two sections that are bonded together. A particular feature of adhesives is the relatively small quantities that are required compared to the weight of the final object.

In accordance with the present invention, a starch is a polymeric carbohydrate comprising a large number of glycosidic bonds. Preferred sources of starch are corn, wheat, potatoes, rice, tapioca and sago, among others.

In accordance with the present invention, a modified starch is a starch that has been chemically modified, for example by hydrolysis. Preferred modified starches in embodiments of the present invention are dextrins.

In embodiments of the present invention, the starch preferably is unmodified wheat starch or corn starch, but can be any of the starches commonly used in an adhesive, that is, all starches and derivatives, which contain sufficient available hydroxyl groups so that a copolymerization reaction can occur between them and other reactants.

Microfibrillated cellulose (also known as “reticulated” cellulose or as “superfine” cellulose, or as “cellulose nanofibrils”, among others) is a cellulose-based product and is described, for example, in U.S. Pat. Nos. 4,481,077, 4,374,702 and 4,341,807. In accordance with the present invention, microfibrillated cellulose has at least one reduced length scale (diameter, fiber length) vis-à-vis non-fibrillated cellulose. In (non-fibrillated) cellulose, which is the starting product for producing microfibrillated cellulose (typically present as a “cellulose pulp”), no, or at least not a significant or not even a noticeable portion of individualized and “separated” cellulose “fibrils” can be found. The cellulose in wood fibres is an aggregation of fibrils. In cellulose (pulp), elementary fibrils are aggregated into microfibrils which are further aggregated into larger fibril bundles and finally into cellulosic fibres. The diameter of wood based fibres is typically in the range 10-50 μm (with the length of these fibres being even greater). When the cellulose fibres are microfibrillated, a heterogeneous mixture of “released” fibrils with cross-sectional dimensions and lengths from nm to μm may result. Fibrils and bundles of fibrils may co-exist in the resulting microfibrillated cellulose. The diameter of the microbrillated cellulose of the present invention is typically in the nanometer range.

In the microfibrillated cellulose (‘MFC’) as described throughout the present disclosure, individual fibrils or fibril bundles can be identified and easily discerned by way of conventional optical microscopy, for example at a magnification of 40×, and/or by electron microscopy.

In embodiments, the microfibrillated cellulose in accordance with the present invention is characterized, among others, by at least one of the following features:

In embodiments of the present invention, the microfibrillated cellulose is characterized in that it results in gel-like dispersion that has a zero shear viscosity, η₀, of at least 2000 Pa·s, preferably of at least 3000 Pa·s or 4000 Pa·s, further preferably of at least 5000 Pa·s, further preferably at least 6000 Pa·s, further preferably at least 7000 Pa·s, as measured in polyethylene glycol (PEG) as the solvent, and at a solids content of the MFC of 0.65%, wherein the measurement method is as described in the description.

The zero shear viscosity, η₀ (“viscosity at rest”) is a measure for the stability of the three-dimensional network making up the gel-like dispersion.

The “zero shear viscosity” as disclosed and claimed herein is measured as described in the following. Specifically, the rheological characterization of the MFC dispersions (“comparative” and “in accordance with the invention”) was performed with PEG 400 as the solvent. “PEG 400” is a polyethylene glycol with a molecular weight between 380 and 420 g/mol and is widely used in pharmaceutical applications and therefore commonly known and available.

The rheological properties, in particular zero shear viscosity was/were measured on a rheometer of the type Anton Paar Physica MCR 301. The temperature in all measurements was 25° C. and a “plate-plate” geometry was used (diameter: 50 mm). The rheological measurement was performed as an oscillating measurement (amplitude sweep) to evaluate the degree of structure in the dispersions and as rotational viscosity measurements, in which case the viscosity was measured as a function of the shear rate to evaluate the viscosity at rest (shear forces→0), as well as the shear thinning properties of the dispersions. The measurement method is further described in PCT/EP2015/001103 (EP 3 149 241).

In embodiments, the microfibrillated cellulose has a water holding capacity (water retention capacity) of more than 30, preferably more than 40, preferably more than 50, preferably more than 60, preferably more than 70, preferably more than 75, preferably more than 80, preferably more than 90, further preferably more than 100. The water holding capacity describes the ability of the MFC to retain water within the MFC structure and this again relates to the accessible surface area. The water holding capacity is measured by diluting the MFC samples to a 0.3% solids content in water and then centrifuging the samples at 1000 G for 15 minutes. The clear water phase was separated from the sediment and the sediment was weighed. The water holding capacity is given as (mV/mT)−1 where mV is the weight of the wet sediment and mT is the weight of dry MFC analyzed. The measurement method is further described in PCT/EP2015/001103 (EP 3 149 241).

Without wishing to be bound by theory, the good water retention properties of MFC, including network forming of MFC with starch, are advantageous in avoiding the leaching of water from the adhesive into the cardboard during processing.

In embodiments of the invention, the MFC has a Schopper-Riegler (SR) value as obtained in accordance with the standard as defined in EN ISO 5267-1 (in the version of 1999) of below 95, preferably below 90, or, in the alternative, cannot be reasonably measured in accordance with the Schopper-Riegler method, as the MFC fibers are so small that a large fraction of these fibers simply passes through the screen as defined in the SR method.

In embodiments of the invention, the microfibrillated cellulose is a non-modified (native) microfibrillated cellulose, preferably a non-modified microfibrillated cellulose derived from plant material.

The viscosity of the starch-based adhesives as described throughout the present application and, in particular, in the examples is determined as the “Lory viscosity” in units of “seconds” and determined by the following method. Lory viscosity is measured with a Lory viscosity cup (Elcometer model 2215/1), according to standards ASTM D 1084-D or ASTM D4212. The Elcometer device consists of a conventional cylindrical cup with a needle fixed to the bottom. The cup is first dipped into the adhesive, which then empties through an escape hole. The flow time is measured as soon as the point of the needle is discernible.

In embodiments of the present invention, the pH value of the final adhesive composition is from 8 to 14, preferably from 10 to 13, further preferably from 11.5 to 12.5.

Without wishing to be bound by theory, it is believed that the addition of microfibrillated cellulose to a starch (derivative)-based adhesive leads to a network structure based on physical and/or chemical interactions between the microfibrillated cellulose units and the starch (derivative) units by way of hydrogen bonding. It is believed that microfibrillated cellulose is an efficient thickener in polar solvent systems, in particular in water, and builds large three dimensional networks of fibrils which are stabilized by hydrogen bonds.

These fibrils have hydroxyl groups on the surface that are dissociated (0) at the high pH prevailing in starch adhesives, this leading to intra and inter-particular interactions. As described above, starch is composed of amylose and amylopectin. Amylose is a helical linear polymer composed of α(1→4)-bound D-glucose units, with hydroxyl groups which are pointed towards outside the helix. The fibril network of microfibrillated cellulose is believed to interact through hydrogen bonding with those groups, building up a protective layer around the amylose chains, thus protecting the starch against high shear degradation and stabilizing the viscosity. Overall, MFC is a network of entangled fibrils that can entrap starch molecule and in that way strengthen the starch composition and improve adhesion properties.

Furthermore, again without wishing to be bound by theory, the water holding capacity of microfibrillated cellulose is believed to prevent water from migrating to and through the paper. Therefore, adding microfibrillated cellulose to starch (derivative) based adhesives is particularly useful for the manufacture of corrugated board, where water migration out of the adhesive into the paper destabilizes the final corrugated board product and may lead to warp and delamination, among others.

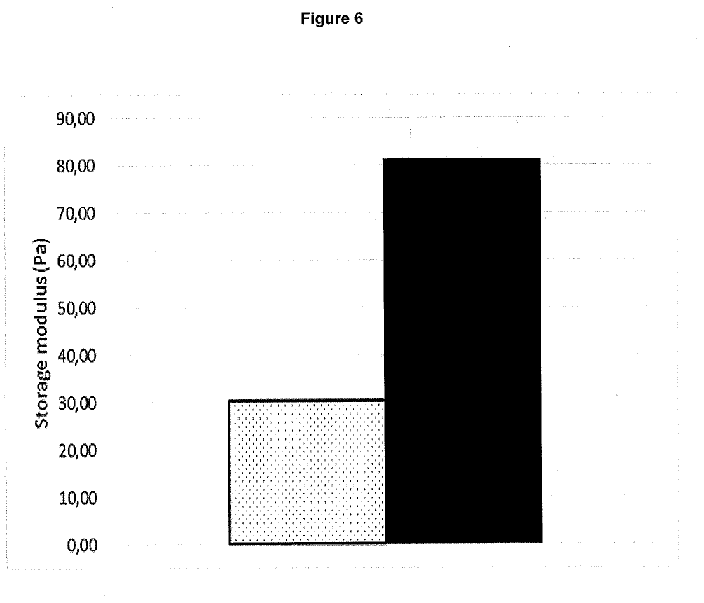

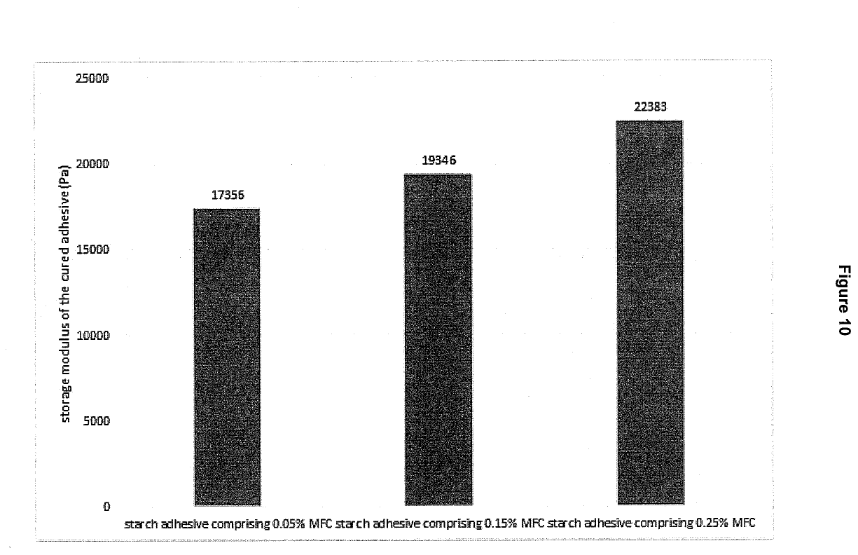

In accordance with the present invention, using microfibrillated cellulose in starch-based compositions as disclosed herein and, in particular in the manufacture of corrugated boards, results in at least one of the following advantages, preferably essentially all of the following advantages, which may also be manifest in the resulting corrugated board:
Microfibrillated cellulose is well dispersible in starch (derivative)-based adhesives
Microfibrillated cellulose can be used to adjust the viscosity of the final adhesive and stabilize the same over time, in particular during storage and also in regard to resistance under high shear
Microfibrillated cellulose provides flexibility for viscosity corrections at any stage of the process
Microfibrillated cellulose is thixotropic (i.e. shows shear thinning), higher overall viscosity can be tolerated
Microfibrillated cellulose shows shear thinning, which improves adhesive application properties
Microfibrillated cellulose increases the storage modulus of the starch adhesive, both in the liquid phase before curing and once the adhesive is cured (see FIGS. 6 and 10)
Microfibrillated cellulose provides viscosity stability over time, in particular over a longer period of storage
Microfibrillated cellulose provides viscosity stability under high shear impact
Experiments on a line for making corrugated cardboard have shown that using a starch based adhesive comprising microfibrillated cellulose (as described below in the Examples Section) leads to an increase in production speed of 25% on chemically treated (specialty) papers to achieve equal or better quality cardboard
MFC increases the initial tack and initial bond strength of the starch adhesive in particular for chemically treated paper
Microfibrillated cellulose improves the quality of the board by reducing water-based defects, which means that flatter boards are obtained, thus increasing speed of the post process steps (printing, cutting, stacking)
Factory trials have shown that 33% reduction in glue consumption can be achieved when producing corrugated boards by using a starch based adhesive comprising microfibrillated cellulose
Microfibrillated cellulose improves the quality of the board by increasing the bond strength of the board
Overall, using the adhesive composition according to the present invention results in stronger boards, for example as measured by the pin adhesion test PAT.

In a further aspect, the present invention relates to corrugated paperboards or cardboards having at least one flute that is or has been at least partly chemically treated and at least one liner comprising the starch-based adhesive composition according to any one of the embodiments as disclosed above.

In a further aspect, the present invention relates to the use of an adhesive composition comprising microfibrillated cellulose in an amount of 0.001% w/w to 10% w/w, dry matter, of the overall adhesive composition, preferably of 0.01% w/w to 5% w/w, dry matter, of the overall adhesive composition, in a process for making corrugated cardboard or paperboard, wherein at least one of the fluting paper or liner paper, or both, has/have been or is/are chemically treated, which paper optionally has surface roughness, as measured according to the ISO 8791-2: 2013, i.e. the Bendtsen air flow method, of below 1000 ml/min, preferably below 500 ml/min, preferably below 250 ml/min, further preferably below 200 ml/min, further preferably below 100 ml/min, further preferably below 50 ml/min or below 25 ml/min, and/or which paper optionally, has an air resistance, as measured according to the ISO 5636-5, i.e. the Gurley method, wherein said air resistance is above 20 sec/100 ml, preferably above 50 sec/100 ml, further preferably above 100 sec/100 ml, further preferably above 150 sec/100 ml, further preferably above 200 sec/100 ml, or further preferably above 250 or 300 sec/100 ml.

In embodiments, the amount of microfibrillated cellulose in the adhesive composition as used in the manufacture of corrugated paperboards or cardboards is from 0.001% w/w, relative to the overall weight of the composition to 10% w/w, preferably from 0.01% w/w to 10% w/w, preferably from 0.02% w/w to 8% w/w, further preferably from 0.05% w/w to 5% w/w, further preferably from 0.05% w/w to 2% w/w, further preferably from 0.05% w/w to 0.5%, further preferably from 0.05% w/w to 0.15% w/w, or the amount of microfibrillated cellulose is from 0.003% w/w to 22% w/w, preferably 0.02% w/w to 20% w/w, preferably 0.04% w/w to 4% w/w, preferably 0.1% w/w to 2% w/w, further preferably 0.2% w/w to 1.4% w/w, even further preferably 0.2% w/w to 0.6% w/w, as measured relative to the overall amount of starch.

In embodiments, the amount of microfibrillated cellulose in the adhesive composition as used in the manufacture of corrugated paperboards or cardboards is from 0.01% w/w, relative to the overall weight of the composition to 8% w/w, preferably from 0.01% w/w to 5% w/w, further preferably from 0.01% w/w to 2% w/w, further preferably from 0.01% w/w to 0.5%, further preferably from 0.01% w/w to 0.15% w/w or from 0.015% w/w to 0.3% w/w, or the amount of microfibrillated cellulose is from 0.003% w/w to 16% w/w, preferably 0.02% w/w to 16% w/w, preferably 0.04% w/w to 4% w/w, preferably 0.04% w/w to 2% w/w, further preferably 0.04% w/w to 1.4% w/w, even further preferably 0.04% w/w to 0.6% w/w, as measured relative to the overall amount of starch in the adhesive composition.

### DETAILED DESCRIPTION OF THE INVENTION

In accordance with the present invention and as further specified in STM D 907-82, Standard Definitions of Terms Relating to Adhesives, published in Volume 15.06—Adhesives, 1984 Annual Book of ASTM Standards, an “adhesive” is understood to be a material that is applied to the surfaces of articles to join these surfaces permanently by an adhesive bonding process. An adhesive is a substance capable of forming bonds to each of the two parts when the final object consists of two sections that are bonded together. A particular feature of adhesives is the relatively small quantities that are required compared to the weight of the final objects.

In accordance with the present invention, a starch (also known as “amylum”) is a polymer consisting of a large number of glucose units joined by glycosidic bonds. Starch is found in large amounts in foods such as potatoes, wheat, maize (corn), rice, tapioca and sago, among others. Starch typically comprises two types of molecules: the linear and helical amylose and the branched amylopectin. Depending on the plant, starch generally contains 20 to 25% amylose and 75 to 80% amylopectin by weight.

While amylopectin can be supplied in cold-water-soluble form, amylose is generally insoluble. Amylose can be dissolved with strong alkali, for example by cooking with formaldehyde or by cooking in water at 150-160° C. under pressure. Upon cooling or neutralization, such amylose dispersions typically form gels at concentrations higher than 2% and will precipitate at concentrations lower than 2%. Amylose fractions are never truly soluble in water and in time will form crystalline aggregates by hydrogen bonding—a process known as retrogradation, or setback. Retrogradation is the cause of viscosity instability mentioned above and found to a varying degree in starch-based adhesives. Amylopectin is more soluble and less prone to retrogradation.

In embodiments of the present invention, the starch preferably is unmodified wheat starch, but can be any of the starches commonly used in the adhesive art, that is, all starches and derivatives, in particular dextrins which contain sufficient available hydroxyl and/or functional groups so that a copolymerization reaction can occur between them and the other two reactants.

A modified starch is a starch that has been chemically modified, for example by hydrolysis, to allow the starch to function properly under conditions frequently encountered during processing or storage, such as high heat, high shear, high pH, freeze/thaw and cooling. Preferred modified starches in embodiments of the present invention are dextrins.

Dextrins are a group of low-molecular-weight carbohydrates produced by the hydrolysis of starch or glycogen. Dextrins are mixtures of polymers of D-glucose units linked by α-(1→4) or α-(1→6) glycosidic bonds. Dextrins can be produced from starch using enzymes like amylases or, for example, by applying dry heat under acidic conditions (pyrolysis). Dextrins produced by heat are also known as pyrodextrins. Dextrins are partially or fully water-soluble and typically yield solutions of low viscosity.

Most starches contain 20-30% by weight of amylose, although certain specialty types can have as little as 0% or as high as 80%. Because of the amylose fraction, starch suspended in cold water is initially unable to act as an adhesive because the starch is so tightly bound in crystalline regions. These granules must be opened through processing to obtain adhesive bonding. Heating in water is the simplest method of breaking up starch granules. On heating in water, starch granules first swell and then burst open with a resulting thickening of the suspension. The temperature at which this thickening of the suspension occurs is called the gelation temperature.

In embodiments of the present invention, (modified) starch-based adhesives are formulated with at least one sodium tetraborate (“borax”). Borax typically provides good adhesion (tack) and machining properties.

Borax is preferably added in amounts of up to 10% w/w, based on the weight of the dry starch.

Sodium hydroxide may be added to convert borax into the more active sodium metaborate.

Plasticizers are sometimes used to control brittleness of the adhesive line and to regulate the speed of drying. Common plasticizers include glycerin, glycols, sorbitol, glucose and sugar. These types of plasticizers may act as a hygroscopic agent to decrease the drying rate of the film. Plasticizers based on saps, polyglycols and sulfonated oil derivates lubricate the layers within the dried adhesive and, thus, impart flexibility. Urea, sodium nitrate, salicylic acid and formaldehyde plasticize by forming a solid solution with the dried adhesive.

In embodiments of the present invention, further additives may be used, such as calcium chloride, urea, sodium nitrate, thiourea and guanidine salts are used as liquefiers to reduce viscosity. These additives may be added at about 5-20% based on dry starch. Improved cold-water resistance may be achieved by adding polyvinyl alcohol or polyvinyl acetate blends. These adhesives will also dissolve in hot water, which is often a benefit. Optimal moisture resistance may be achieved through the addition of thermosetting resins, such as urea formaldehyde or resorcinol formaldehyde.

Mineral fillers, such as kaolin clay, calcium carbonate and titanium dioxide, may be added to reduce cost and control penetration into porous substrates. These additives may be added at concentrations of 5-50%.

Other additives that may be added include but are not limited to preservatives, bleaches, and defoamers. Preservatives that are preferred to prevent microbial activity include formaldehyde (35% solids) at 0.02-1.0%, copper sulfate at about 0.2%, zinc sulfate, benzoates, fluorides and phenols. Preferred bleaching agents include sodium bisulfite, hydrogen and sodium peroxide, and sodium perborate. Organic solvents may be added to improve adhesion to waxed surfaces.

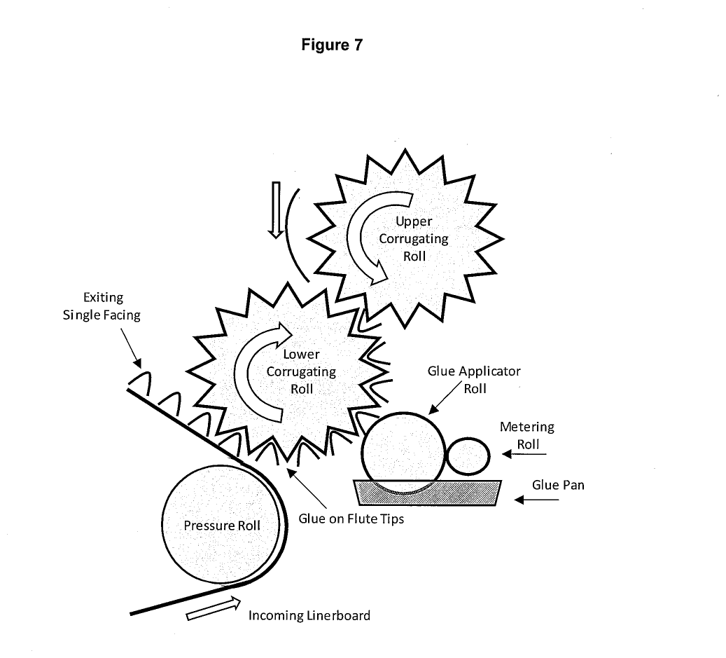

FIG. 7 schematically depicts a continuous production line for making corrugated cardboard (single facer).

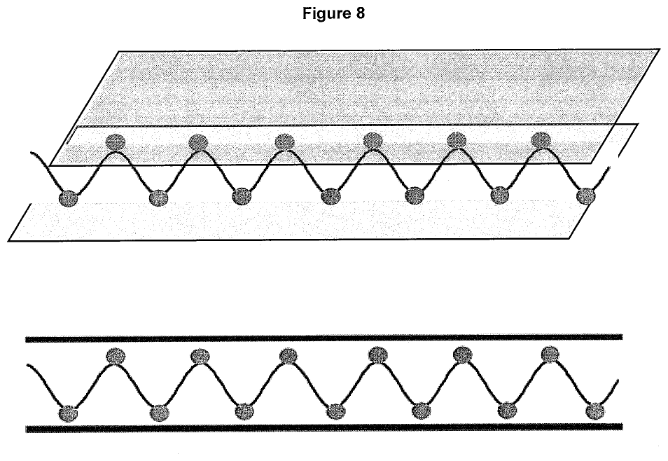

FIG. 8 schematically depicts a layer of cardboard comprising one layer of corrugated paper having the flutes tips coated with adhesive as well as an upper and a lower liner. A schematic illustration of “fluted” (“corrugated”) piece of paper, i.e. a piece of paper that has been brought into contact with heat or steam, or both, on corrugating rolls, in order to have a corrugated (“fluted”) shape is illustrated, which also shows how to exemplary apply glue to the tips of the flutes. In embodiments of the present invention, the glue may be applied along the entire tip or only along parts thereof. The figure also illustrates an upper and a lower liner as applied onto the upper and lower tips of the fluted paper, called single facer and double backer side of the board, resulting in a single walled cardboard.

Combining the experiments for measuring initial bonding strength and initial tack grade, together with experiments run on a corrugator machine from BHS (wet end) and Fosber (dry end) have shown that using a starch based adhesive comprising microfibrillated cellulose (as described below in the Examples Section) leads to the following advantages, among others:
an increase in production speed for processing specialty papers, including, in particular chemically treated papers, of up to 25%, while achieving equal or better quality cardboard, thus saving time and facilitating the post process steps due to flatter boards.
an increase in bond strength between the flute and liners of the board.

This translates to saving time and processing costs [less heat (energy) needed for curing due to less water to evaporate when less adhesive is applied; deduced water impact/defects/warp on the paper during process and post process: achieves flatter cardboards].

“Microfibrillated cellulose” (MFC) in accordance with the present invention is to be understood as relating to cellulose fibers that have been subjected to a mechanical treatment resulting in an increase of the specific surface and a reduction of the size of cellulose fibers, in terms of cross-section (diameter) and/or length, wherein said size reduction preferably leads to “fibrils” having a diameter in the nanometer range and a length in the micrometer range.

Microfibrillated cellulose (also known as “reticulated” cellulose or as “superfine” cellulose, or as “cellulose nanofibrils”, among others) is a cellulose-based product and is described, for example, in U.S. Pat. Nos. 4,481,077, 4,374,702 and 4,341,807. According to U.S. Pat. No. 4,374,702 (“Turbak”), microfibrillated cellulose has distinct properties vis-à-vis cellulose products not subjected to the mechanical treatment disclosed in U.S. Pat. No. 4,374,702. In particular, the microfibrillated cellulose described in these documents has reduced length scales (diameter, fiber length), improved water retention and adjustable viscoelastic properties. MFC with further improved properties and/or properties tailor-made for specific applications is known, among others, from WO 2007/091942 and WO 2015/180844.

In cellulose, which is the starting product for producing microfibrillated cellulose (typically present as a “cellulose pulp”), no, or at least not a significant or not even a noticeable portion of individualized and “separated” cellulose “fibrils” can be found. The cellulose in wood fibres is an aggregation of fibrils. In cellulose (pulp), elementary fibrils are aggregated into microfibrils which are further aggregated into larger fibril bundles and finally into cellulosic fibres. The diameter of wood based fibres is typically in the range 10-50 μm (with the length of these fibres being even greater). When the cellulose fibres are microfibrillated, a heterogeneous mixture of “released” fibrils with cross-sectional dimensions and lengths from nm to μm may result. Fibrils and bundles of fibrils may co-exist in the resulting microfibrillated cellulose.

In the microfibrillated cellulose (‘MFC’) as described throughout the present disclosure, individual fibrils or fibril bundles can be identified and easily discerned by way of conventional optical microscopy, for example at a magnification of 40×, and/or by electron microscopy.

In principle, any type of microfibrillated cellulose (MFC) can be used in accordance with the present invention, as long as the fiber bundles as present in the original cellulose pulp are sufficiently disintegrated in the process of making MFC so that the average diameter of the resulting fibers/fibrils is in the nanometer-range and therefore more surface of the overall cellulose-based material has been created, vis-à-vis the surface available in the original cellulose material. MFC may be prepared according to any of the processes described in the art, including the prior art specifically cited in the “Background”-Section above.

In accordance with the present invention, there is no specific restriction in regard to the origin of the cellulose, and hence of the microfibrillated cellulose. In principle, the raw material for the cellulose microfibrils may be any cellulosic material, in particular wood, annual plants, cotton, flax, straw, ramie, bagasse (from sugar cane), suitable algae, jute, sugar beet, citrus fruits, waste from the food processing industry or energy crops or cellulose of bacterial origin or from animal origin, e.g. from tunicates.

In a preferred embodiment, wood-based materials are used as raw materials, either hardwood or softwood or both (in mixtures). Further preferably softwood is used as a raw material, either one kind or mixtures of different soft wood types. Bacterial microfibrillated cellulose is also preferred, due to its comparatively high purity.

In principle, the microfibrillated cellulose in accordance with the present invention may be unmodified in respect to its functional groups or may be physically modified or chemically modified, or both. In preferred embodiments, the microfibrillated cellulose is non-modified or physically modified, preferably non-modified.

Chemical modification of the surface of the cellulose microfibrils may be achieved by various possible reactions of the surface functional groups of the cellulose microfibrils and more particularly of the hydroxyl functional groups, preferably by: oxidation, silylation reactions, etherification reactions, condensations with isocyanates, alkoxylation reactions with alkylene oxides, or condensation or substitution reactions with glycidyl derivatives. Chemical modification may take place before or after the defibrillation step.

The cellulose microfibrils may, in principle, also be modified by a physical route, either by adsorption at the surface, or by spraying, or by coating, or by encapsulation of the microfibril. Preferred modified microfibrils can be obtained by physical adsorption of at least one compound. The MFC may also be modified by association with an amphiphilic compound (surfactant).

In a preferred embodiment of the present invention, the microfibrillated cellulose as used in step (iii) is prepared by a process, which comprises at least the following steps:
(a) subjecting a cellulose pulp to at least one mechanical pretreatment step;
(b) subjecting the mechanically pretreated cellulose pulp of step (a) to a homogenizing step, which results in fibrils and fibril bundles of reduced length and diameter vis-à-vis the cellulose fibers present in the mechanically pretreated cellulose pulp of step (a), said step (b) resulting in microfibrillated cellulose;
   wherein the homogenizing step (b) involves compressing the cellulose pulp from step (a) and subjecting the cellulose pulp to a pressure drop.

The mechanical pretreatment step preferably is or comprises a refining step. The purpose of the mechanical pretreatment is to “beat” the cellulose pulp in order to increase the accessibility of the cell walls, i.e. to increase the surface area.

A refiner that is preferably used in the mechanical pretreatment step comprises at least one rotating disk. Therein, the cellulose pulp slurry is subjected to shear forces between the at least one rotating disk and at least one stationary disk.

Prior to the mechanical pretreatment step, or in addition to the mechanical pretreatment step, enzymatic (pre)treatment of the cellulose pulp is an optional additional step that may be preferred for some applications. In regard to enzymatic pretreatment in conjunction with microfibrillating cellulose, the respective content of WO 2007/091942 is incorporated herein by reference. Any other type of pretreatment, including chemical pretreatment is also within the scope of the present invention.

In the homogenizing step (b), which is to be conducted after the (mechanical) pretreatment step, the cellulose pulp slurry from step (a) is passed through a homogenizer at least once, preferably at least two times, as described, for example, in PCT/EP2015/001103, the respective content of which is hereby incorporated by reference.

### EXAMPLES

### Example 1

Preparation of Microfibrillated Cellulose (MFC)

MFC as used to make the compositions in accordance with the present invention is commercially available and commercialized, for example, by Borregaard as “Exilva Microfibrillated cellulose PBX 01-V”, based on cellulose pulp from Norwegian spruce (softwood).

The MFC used in the example was present as a paste, having a solids content of 10%, i.e. the dry matter content of microfibrillated fibers in the MFC paste was 10%, while the remaining 90% were water, which was the sole solvent in this case.

### Example 2

Preparation of a Starch Based Adhesive Comprising Borax (Comparative Example)

A starch-based adhesive as known from the art was prepared based on the following components and using the following steps:
750 kg of primary water
180 kg of primary starch (wheat)
   Stirring for 30 sec, temperature 36.5° C.; add:
100 kg of water
16.5 kg Primary caustic soda (31%)
80 kg of water

### Stirring for 30 sec

Viscosity control 1: 10 sec

### Stirring for 840 sec

Viscosity control 2: 33.8 sec
260 kg secondary water
Disinfectant: 0.4 kg
280 kg secondary starch (wheat)
   Stirring for 30 sec at a temperature of 35° C.
   2.5 kg of borax

### Stirring for 600 sec

Viscosity control 3, final: 28 sec

Borax was added after the addition and mixing of the secondary non-swollen starch. The concentration of borax in the final formulation was 0.15%. The Lory viscosity of this starch-based adhesive according to the art including borax was decreasing readily with mixing time, at high shear.

Preparation of a Starch Based Adhesive Comprising Microfibrillated Cellulose (in Accordance with the Present Invention)

A starch-based adhesive in accordance with the present invention was prepared based on the following components and using the following steps:
750 kg of primary water
180 kg of primary wheat starch
   Stirring for 30 sec, temperature 36.5° C.
100 kg of water
16.5 kg Primary caustic soda (31%)
80 kg of water

### Stirring for 30 sec

Viscosity control 1: 10 sec

### Stirring for 840 sec

Viscosity control 2: 33.8 sec
260 kg secondary water
Disinfectant: 0.4 kg

### Temperature 35° C.

280 kg secondary wheat starch

### Stirring for 30 sec

2.5 kg of borax

### Stirring for 60 sec

20 kg of MFC (Exilva PBX 01-V)

### Stirring for 600 sec

21 kg of water
   Viscosity control 3, final: 32 sec
   Lory viscosity was 34.

The adhesive consisted of a primary starch portion in which most of the granules are partially swollen, in which uncooked raw starch was suspended. Microfibrillated cellulose was added under high speed stirring (1500 rpm), after the addition and inmix of the borax. The concentration of MFC in the final formulation was 0.12%.

Lory viscosity was measured with a Lory viscosity cup (Elcometer 2215/1), which is commonly used in the adhesive, paint and coatings industry and which essentially consists of a conventional cylindrical cup with a needle fixed to the bottom. The cup is first dipped into the adhesive, which then empties through an escape hole. The flow time was measured as soon as the point of the needle was visible.

Stability Test Over Time

Both for the reference and the starch-based adhesive with MFC, the Lory viscosity and Brookfield viscosity were measured initially, and over time under laboratory conditions, i.e. at 20° C. and under standard ambient conditions. The samples were left on the bench without stirring. For the reference adhesive, the initial Lory viscosity was 36 seconds.

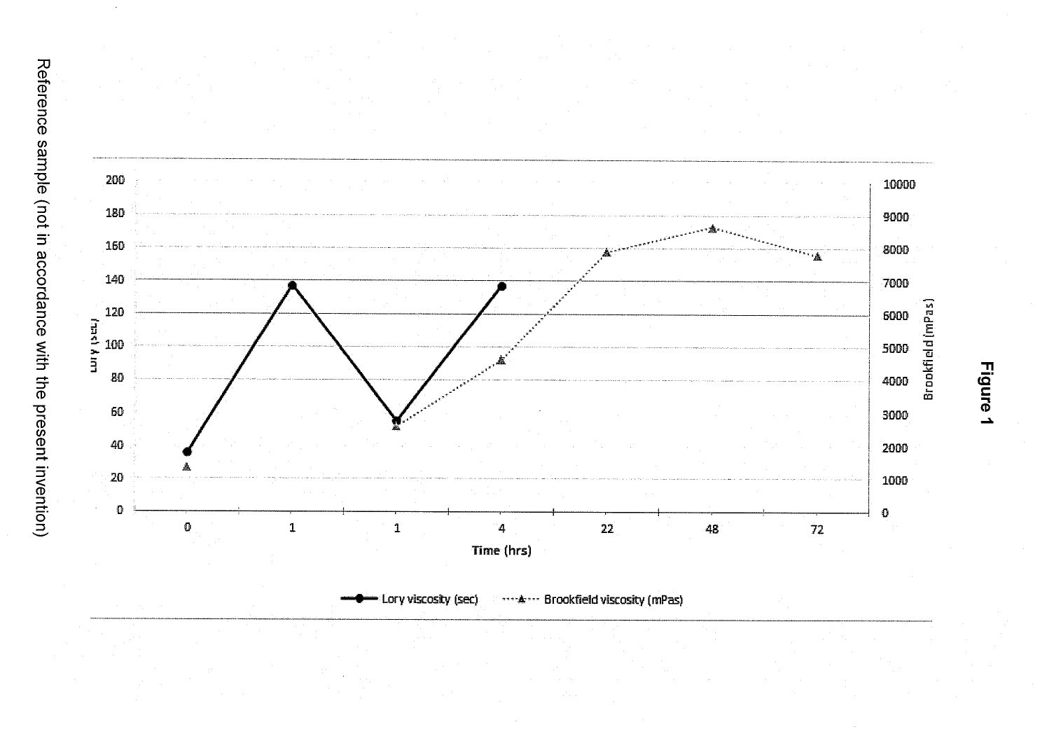

After 1 hour, the viscosity was 137 seconds (critical viscosity), and the reference adhesive could no longer be measured by Lory viscosity without being pre-stirred for 30 seconds by a propeller mixer. After 4 hours, the viscosity of the reference adhesive was too high to be measured by Lory viscosity, even with 30 seconds pre-stirring (see FIG. 1).

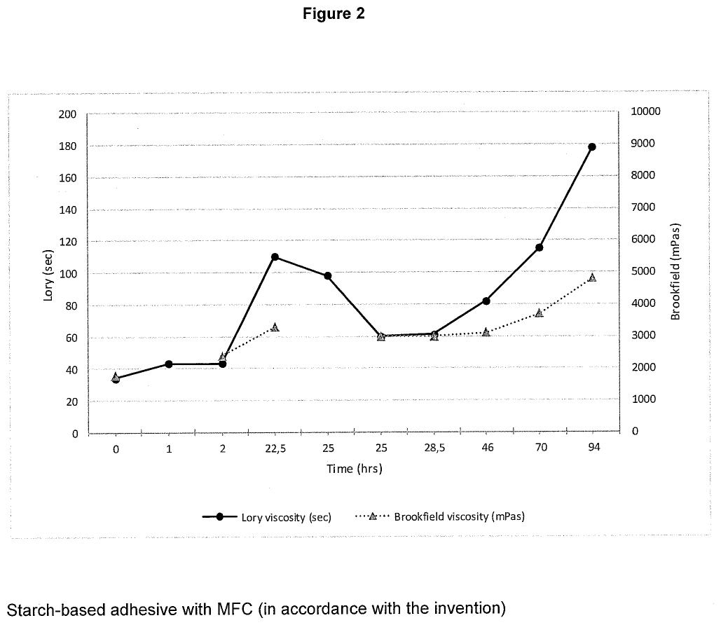

For the starch-based adhesive in accordance with the present invention, i.e. the adhesive with MFC, the initial Lory viscosity was 34 and only increased to 43 seconds 1 and 2 hours after preparation. Moreover, the Lory viscosity was still measureable 22.5 hours after preparation and the critical viscosity limit for measuring Lory viscosity was not reached before 25 hours after preparation. After 25 hours, pre-stirring with propeller mixer for 30 seconds had to be performed before the measurements. The final measurement of Lory viscosity was performed 94 hours after the adhesive was prepared (see FIG. 2).

Brookfield viscosity measurements for the reference starch-based adhesive and the starch-based adhesive with MFC, likewise show a slower increase in viscosity over time with MFC added to the starch-based adhesive (see FIGS. 1 and 2). Brookfield viscosity was measured with Brookfield Viscometer—RVT model, spindle no. 4.

Overall, the viscosity measurements consistently demonstrate that the starch-based adhesive comprising microfibrillated cellulose is far more stable in regard to viscosity and over time than the reference starch-based adhesive without microfibrillated cellulose.

### Example 3

Testing the Starch Based Adhesive from Example 2 in Accordance with the Present Invention in Corrugated Cardboards

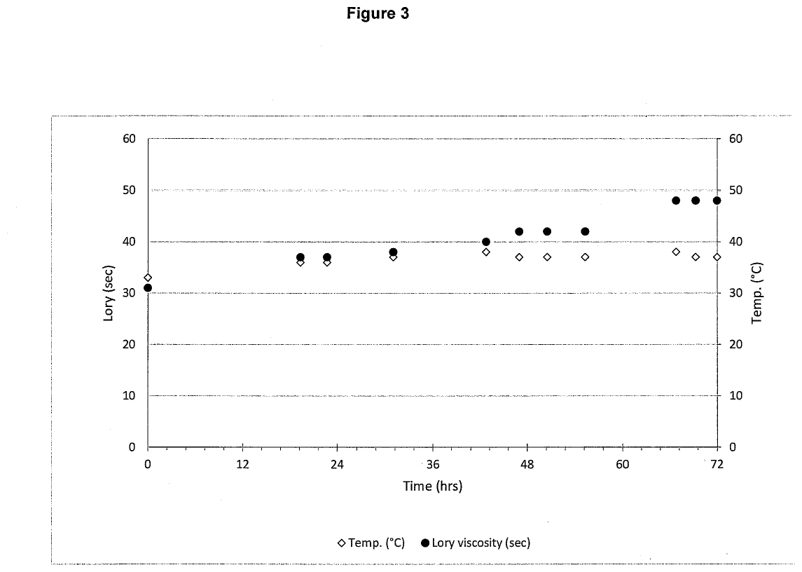

The Lory viscosity and temperature for the starch-based adhesive with MFC were also measured over time in the storage tank, see FIG. 3. To prevent sedimentation and reduce the viscosity of the starch-based adhesives, the glues are stirred for 5 minutes every hour. For the starch-based adhesive with MFC the sufficient time between the stirring was tested: The first 24 hours of storage, the adhesive was stirred for 5 minutes every hour, after 24-48 hours the stirring was 5 minutes every third hour, and from 48-72 hours the adhesive was stirred for 5 minutes every fourth hour. Compared to the reference starch-based adhesive, the frequency of stirring during storage was significantly reduced for the adhesive with MFC.

The Lory viscosity of the starch-based adhesive with MFC was measured to be 48 seconds after 72 hours storage in tank and the starch-based adhesive could be used directly without adjustment with water for the production of corrugated boards. The temperature of the starch-based adhesive in the tank was 37° C. (see FIG. 3).

Both the starch-based adhesive with MFC (72 hours) and the reference starch-based adhesive (fresh) were tested on quality BB25 b-flute (180 g/m² EK liner/110 g/m² SC fluting (with an air resistance above 200 sec/100 ml)/180 g/m² EK liner).

TABLE 1
Standard tests

| | | Adhesion |
|---|---|---|
| Conditions | Grammage | strength |
| 23° C.-50 RH % | g/m² | N/m |
| ISO 187 | ISO 536 | Fefco nr.11 |

As for making corrugated cardboards, a corrugator from BHS (wet end) and Fosber (dry end) was used, which is a set of machines designed to bring together several sheets of paper to form single, double or triple wall board in a continuous process. The process starts with a paper sheet conditioned with heat and steam on corrugating rolls in order to be given its fluted shape in the single facer.

Starch-based adhesive is then applied to the tips of the flutes on one side and the inner liner is glued to the fluting (see FIGS. 7 and 8 for a schematic depiction of such a process). The corrugated fluting medium with one liner attached to it (single facer) is then brought to the double backer where the outer liner is glued to the single facer.

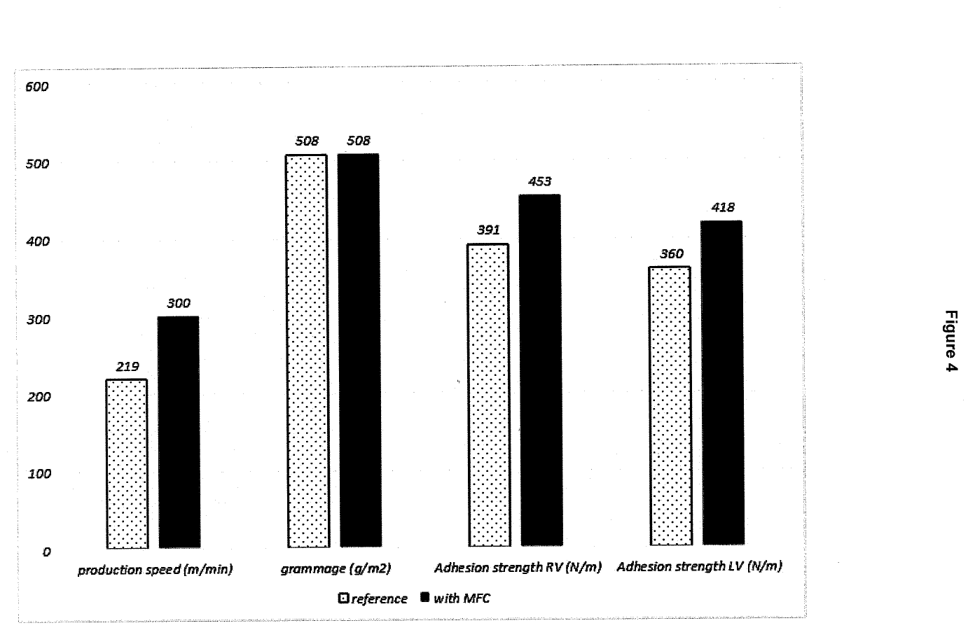

FIG. 4 shows a comparison of the grammage and adhesion strength of corrugated boards, using the reference starch-based adhesive run at 219 m/min (left column) compared to the starch-based adhesive with MFC run at 300 m/min (right column, respectively).

It is noteworthy that the reference adhesive tested was a fresh glue made the same day as the corrugated boards production, while the glue with MFC was 72 hours old and was used with no addition of water.

It can be seen from FIG. 4 that the starch-based adhesive containing MFC provides greater adhesion strength to the corrugated boards (on both sides, inner and outer liner, respectively RV and LV), even when the production is run 37% faster. Since the grammage of the cardboard was similar for both adhesives, the improvement of the adhesion strength can be compared and improvements can be attributed to the better performance of the starch-based adhesive with MFC. It was also observed that the boards produced with the MFC starch-based adhesive were flatter than the boards produced with the reference starch adhesive.

Overall, the viscosity of the starch-based adhesive with MFC is unexpectedly stable over a long period of time, in particular during storage (at least 72 hours) contrary to a starch-based adhesive without MFC, the viscosity of which increases dramatically already after 1 hour.

Moreover, the starch-based adhesive with MFC is usable for corrugated board production even after 72 hours storage and performs even better than a fresh made reference at high speed production. Therefore production can be run at faster speeds, while better quality and flatter boards are obtained.

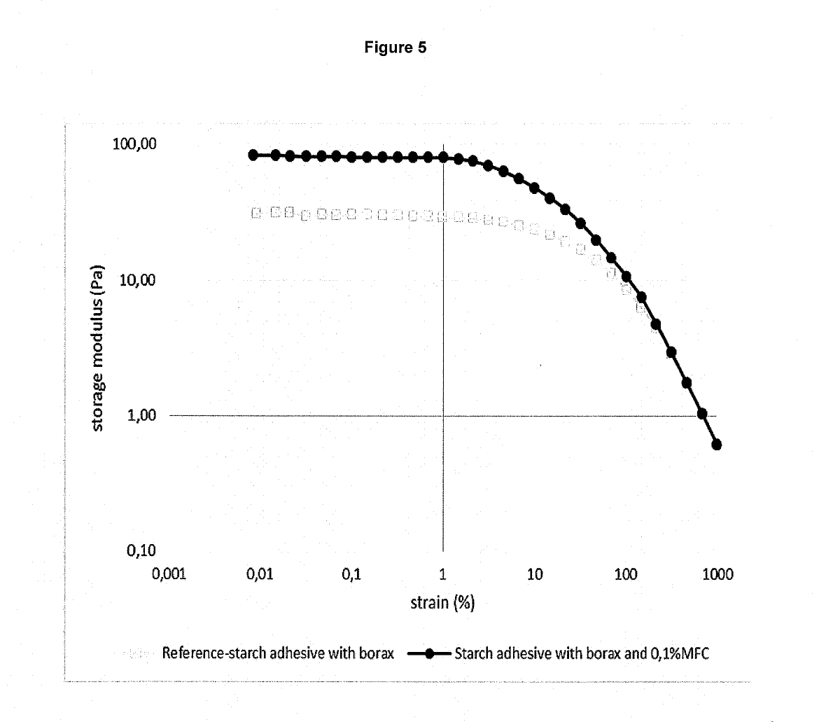

Finally, as can be seen from FIG. 5 (upper curve: starch based adhesive with borax and microfibrillated cellulose; lower curve: starch-based adhesive with borax but no microfibrillated cellulose) and from FIG. 6 (left column: no microfibrillated cellulose), using microfibrillated cellulose as an additive increases the storage modulus of the adhesive (measured by amplitude sweep at 25° C.).

Starch adhesives in accordance with the present invention comprising microfibrillated cellulose, were also tested in factory trials for the manufacturing of corrugated boards comprising a range of specialty papers known to have challenging glueability, including among others high performance semi chemical type fluting paper such as Hidroplus saica (Saica), Powerflute (Mondi), and New Billerud Flute (Billerud Korsnäs), and high performance recycled papers (typically reinforced or fiber selected) from Smurfit Kappa, such as Hoya Papier 125 RC-HP3 and Roermond 150 RC-HP3, resulting in improved glueability, board quality and higher production speed compared to the comparative reference glue with no microfibrillated cellulose.

### Example 4

The Effect of MFC Concentration on the Gelatinization Speed and Storage Modulus of the Cured Adhesive

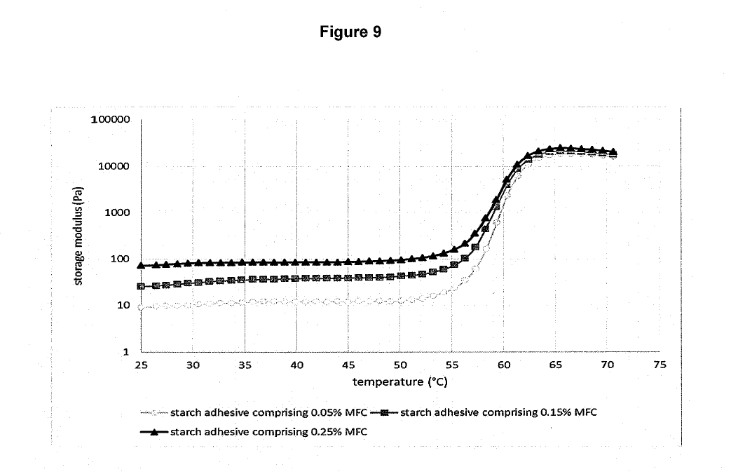

FIG. 9 and FIG. 10 show the effect of MFC concentration on the gelatinization speed of the starch adhesive, and storage modulus of the cured adhesive. The solid content and caustic soda concentration are equal for the three glues, which do not comprise borax. The MFC content varies from 0.05 to 0.25 w-% of the overall adhesive composition. The higher the MFC concentration, the higher the storage modulus of the cured adhesive and the stronger the cured adhesive becomes (see FIG. 10), which clearly demonstrates that the microfibrillated cellulose in concentrations up to 0.25% w/w is contributing to an increased bond strength. In addition to that, the higher the concentration of MFC, the slower the gelatinization speed and the longer the open time of the adhesive is (see FIG. 9). The advantage of a long open time in a full scale production is that there is more time to adjust for warps on the boards which results in flatter and more stable boards. Furthermore, the longer the “open” time, the more time for the secondary starch to fully gelatinize, and for the formation of a strong entangled microfibrillar cellulose-starch gel network. In fact, the MFC concentration can be varied to control the bond strength of the adhesive as well as its open time, allowing for a better control of the warps and an overall better quality of the corrugated boards.

### Example 5

The Theology and Viscosity Stabilizing Effect of MFC Upon High Shearing Impact

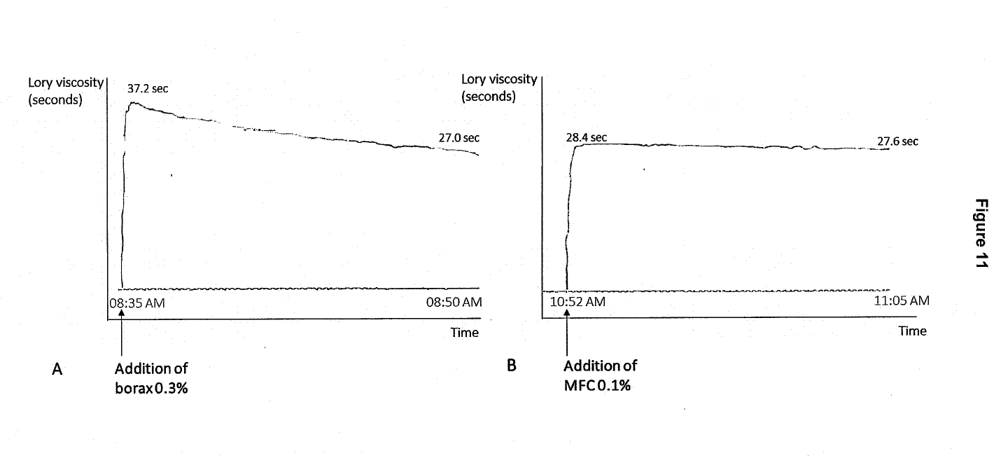

The microfibrillated cellulose is providing an extremely high shear stable viscosity, here shown for a Stein-Hall starch adhesive comprising 0.1% MFC and no borax (FIG. 11 B). After an instant increase in viscosity upon addition of MFC, the viscosity remains constant under high shear stirring for 15 minutes (FIG. 11 B). In comparison, the viscosity of the reference adhesive comprising 0.3% borax (FIG. 11 A), decreased by 27% after 15 minutes of high shear stirring. When preparing a starch adhesive with MFC, a target viscosity of the adhesive can be predetermined and achieved, regardless of stirring time during manufacturing, before it is used on the corrugator or transferred to the storage tank. Having a viscosity stable starch adhesive, which is provided by MFC, the corrugator can be run with the same settings for the adhesive over time, facilitating a continuous production and high production volumes of corrugated boards. This Example shows that MFC can be used advantageously to replace parts or all of the borax as typically used as an additive in starch based adhesives.

### Example 6

A starch based adhesive comprising borax (comparative example, adhesive 1 in Table 2) and a starch based adhesive comprising borax and microfibrillated cellulose (in accordance with present invention, adhesive 2 in Table 2) were prepared based on the following components and using the following steps given in Table 2.

TABLE 2
Formulations and process steps for the preparation of a starch based adhesive
comprising borax (adhesive 1; reference example)
and a starch based adhesive comprising borax and microfibrillated cellulose
(adhesive 2, in accordance with the present invention)

| | | | | 1 | 2 |
|---|---|---|---|---|---|
| Adhesive | | | | Borax | Borax MFC |
| Caustic concentration (undiluted liquid) | | | | 100.00% | 100.00% |
| Prepared caustic concentration ( “0” means no dilution) | | | | 0.00% | 0.00% |
| Starch | | Carrier starch | | Corn | Corn |
| | | Main starch | | Corn | Corn |
| Glue | Carrier | Warm water (g) | | 1400.00 | 1400.00 |
| | | Raw corn starch (g) | | 102.00 | 131.00 |
| | | Caustic soda (g) | | 23.00 | 21.00 |
| | | | Caustic solid (g) | 23.00 | 21.00 |
| | | | water (g) | 0.00 | 0.00 |
| | | Water for caustic soda dilution (g) | | 0.00 | 0.00 |
| | Main | Warm water (g) | | 1500.00 | 1500.00 |
| | | Raw corn starch (g) | | 934.00 | 905.00 |
| | | Exilva PBX 01-V (10%) | | 0.00 | 0.00 |
| | | | MFC Dry Solid | 0.00 | 1.04 |
| | | | water | 0.00 | 9.36 |

| | Borax deca hydrate | 17.60 | 10.40 |
|---|---|---|---|
| Parameters | Total starchy liquid qty (g) | 3976.6 | 3977.8 |
| | Total water qty (g) | 2900.0 | 2909.4 |
| | Starch qty (g) | 1036.0 | 1036.0 |
| | water rates | 2.80 | 2.81 |
| | Starch concentration | 26.05% | 26.04% |
| | Caustic concentration in carrier | 1.51% | 1.35% |
| | Caustic concentration in carrier (vs Starch) | 22.55% | 16.03% |
| | Caustic concentration (Final) | 0.578% | 0.528% |
| | MFC dry solid ratio (vs Starch) | 0.00% | 0.10% |
| | Borax ratio (vs Starch) | 1.70% | 1.00% |
| | Starch/Carrier ratio | 9.85% | 12.64% |
| | Starch concentration in carrier (before dilution) | 6.69% | 8.44% |
| | Caustic concentration (after diluted by carrier) | 0.50% | 0.68% |
| | Liquid qty in carrier (g) | 3121.0 | 1573.0 |
| | Solid concentration | 27.07% | 26.86% |

| | | | |
|---|---|---|---|
| Viscosity of glue | Sec | 30 | 30 |
| by lory cup | Temperature ° C. degree | 38 | 38 |

For both adhesives 1 and 2, the carrier and main glue component were prepared under stirring with high speed for 35 sec at 38° C., respectively. The reference starch adhesive with borax (adhesive 1) comprises 1.7% borax (ratio versus starch). The adhesive 2 comprises 0.1% microfibrillated cellulose (dry solid ratio versus starch) and 1.0% borax (ratio versus starch). The microfibrillated cellulose was added prior to the borax. The viscosities of the final adhesives were measured using a Lory viscosity cup. The Lory viscosities were 30 seconds for both the borax reference adhesive (adhesive 1) and the adhesive with MFC (adhesive 2).

Gluing of the Papers Using the Ironing Method

Five separate batches (parallels) of each adhesive, the borax reference adhesive (adhesive 1) and the adhesive comprising borax and MFC (adhesive 2), were prepared. 3.5 g/m² of the respective adhesives were applied with bar coater #46 onto a glass plate, and then applied to a single face board of 5 cm/11-flute, by placing the single face board with the flute side down onto the thin film. A piece of liner board was positioned on the adhesive coated flutes. Heating on a hot iron board at 130° C. was applied for 3 seconds under pressure. For temperature control, a small temperature sensor was placed in between the flute and the liner board. The adhesion test board comprised K280 liner, which has polyacrylamide impregnated reinforced flute having a paper weight of 200 g/m² and an air resistance (Gurley) above 80 sec/100 ml (=single face board), glued together with K280 liner as the liner board.

Peeling Test for Initial Strength Measurement and Estimation of Initial Tack

An initial strength measurement was carried out after 3 seconds, on 5 cm/11-flute test boards that have been glued together using the previously described ironing method. The test board is pulled apart (peeled) from one end with a Hayashiroku nominal standard hand strength (by the same laboratory engineer). The initial bonding strength is then measured indirectly by recording the number of flutes visible after this standard peeling. The results (average numbers from 4 repeats on each of the 5 batches of adhesive at each recipe—20 tests per recipe) are given in Table 3.

TABLE 3
Initial bond strength measured by peeling test

| | 1. Borax | 2. Borax |
|---|---|---|
| Adhesive | reference | and MFC |
| Number of flutes visible | 3 | 2 |
| after standard peeling | | |

Qualitative Grading of Initial Tack

Further, the initial tack was determined for each of the peeling tests, being measured qualitatively according to the observation of the number of fibers pulled upright by the peeling force. The more fibers stick upwards, indicating they have adhered strongly to the bonded surface, the greater the initial tack. The result is graded according to a scale where 1 is no tack and 5 is most tack (tackiness grade). The order of decreasing initial tack was as follows: Adhesive 2 (borax and MFC)>Adhesive 1 (borax reference). The initial tack grades are found in Table 4 below.

TABLE 4
Initial tack grades

| | 1. Borax | 2. Borax |
|---|---|---|
| Adhesive | reference | and MFC |
| Tackiness Grade | 4 | 5 |

Combination of Initial Bonding Strength and Initial Tack Grade to Estimate Machine Running Speed

Combining the measurements of initial bonding strength and tackiness grade, an estimate can be made by one skilled in the art for the attainable machine speed in a commercial setting. A low result for the number of flutes visible following the peeling test (high initial bonding strength) combined with a high number for tackiness grade (high initial tack) will allow the production speed of the machine to be higher whilst still producing optimally glued product. The reference point in the machine speed estimation can be reasonably based on adhesive recipe 1 (borax reference), since this is representative of a standard recipe for adhesives used in the Japanese corrugated cardboard industry. Within this area, it is known that the machine speed is limited to 200 m/min when bonding polyacrylamide impregnated reinforced flutes. The results for the initial bond strength and tackiness grades and the resultant estimates for attainable machine speed are compiled in Table 5 below.

TABLE 5
Initial bond strength and tackiness grades
and estimates for attainable machine speed

| | 1. Borax | 2. Borax |
|---|---|---|
| Adhesive | reference | and MFC |
| Tackiness grade | 4 | 5 |
| No of flutes visible after | 3 | 2 |
| standard peeling | | |
| Attainable machine speed | 200 | 250 |
| (m/min) | | |

Based on the clearly improved combination of initial bonding strength and initial tack of the adhesive recipe 2 (borax and MFC) compared with standard adhesive recipe 1 (borax reference), it is estimated that a 25% improvement in machine speed (250 m/min) can be obtained for industrial manufacture of corrugated cardboard using polyacrylamide impregnated reinforced flutes if adhesive recipe 2 comprising microfibrillated cellulose is used.

As demonstrated, the incorporation of microfibrillated cellulose in starch-based adhesives, improves both the initial tack and initial bond strength of the starch adhesive, allowing for high(er) speed production of corrugated cardboards. This applies, in particular, for the production of corrugated cardboards comprising chemically treated, in particular impregnated or surface coated fluting papers, here demonstrated for a polyacrylamide impregnated fluting paper.

Test Procedure for Measuring Adhesive Strength (Cured)

The adhesive strength in Newton (N) was measured with a standard pin tester (TCM-R-500) after 24 hours bonding at ambient laboratory conditions, following gluing according to the ironing method described above. Adhesive strength was measured on a standard 5 cm long, 11-flute test board made with polyacrylamide impregnated reinforced flutes. The pin tester as used is a standard piece of equipment in the corrugated cardboard industry. When the standard 5 cm test board is inserted in the machine, pins enter into the flutes from both sides. The machine then pulls apart the test board and the force required to do this is recorded (in N). Five batches of each glue recipe were made up. 10 repeats of adhesive strength were made for each glue batch (50 repeats per recipe). The measured adhesive strengths (average numbers of 50 repeats per recipe) for the adhesives 1 (borax reference) and 2 (borax and MFC) are given in Table 6.

TABLE 6
Adhesive strength after 24 hours curing

| | | | 1 | 2 |
|---|---|---|---|---|
| Adhesive | | | Borax | Borax MFC |
| Adhesive | Temperature | | 130 | 130 |
| strength | ° C. degree | | | |
| after 24 | Press time (sec) | | 3 | 3 |
| hrs curing | Adhesive | Average N | 311 | 318 |
| | strength | Max N | 350 | 366 |
| | | Min N | 268 | 266 |
| | Peeling by hand | | Excellent | Excellent |

The adhesive strength after 24 hours of curing of the test boards was somewhat higher for the adhesive 2 comprising microfibrillated cellulose, compared to the adhesive 1, borax reference adhesive (see Table 6). Both the reference adhesive 1, comprising 1.7% borax (ratio versus starch), and the adhesive 2, comprising 1.0% borax and 0.1% microfibrillated cellulose (ratio versus starch), achieved excellent strength measured by hand peeling.

1. A process for making corrugated paperboards or cardboards, said process comprising at least the following steps:
providing a starch-based adhesive composition comprising:
at least one starch and/or at least one starch derivative, in an amount of 5% w/w to 60% w/w, dry matter, of the adhesive composition overall;
at least one solvent in an amount of 30% w/w to 95% w/w of the adhesive composition overall:
microfibrillated cellulose in an amount of 0.001% w/w to 10% w/w, dry matter, of the adhesive composition overall;
providing fluting paper and liner paper for corrugated paperboard or cardboard, wherein said fluting paper or said liner paper or both, is or has/have been at least partly chemically treated;
applying said starch-based adhesive to at least a part of tips of the flutes of a corrugated piece of paper, on at least one side; and
in a corrugator, applying at least one liner onto said corrugated piece of paper and preparing a single, double, triple or further multiple wall cardboard.

2. The process according to claim 1, wherein the amount of microfibrillated cellulose in the adhesive composition is from 0.01% w/w, relative to the overall weight of the composition to 8% w/w and/or the amount of microfibrillated cellulose is from 0.003% w/w to 16% w/w as measured relative to an overall amount of starch in the adhesive composition.

3. The process according to claim 1, wherein an overall amount of starch in said adhesive composition is from 15% w/w to 50% w/w of the adhesive composition overall.

4. The process according to claim 1, wherein the pH value of the adhesive composition is from 8 to 14.

5. The process according to claim 1, wherein the at least one starch is a native starch, or a chemically or a physically modified starch, or a starch derivative, or a mixture thereof.

6. The process according to claim 1, wherein the microfibrillated cellulose (MFC) is characterized in that it results in gel-like dispersion that has a zero shear viscosity, η₀, of at least 2000 Pa*s as measured in a polyethylene glycol (PEG) solvent, and at a solids content of the MFC of 0.65%.

7. The process according to claim 1, wherein the microfibrillated cellulose (MFC) is characterized by a water holding capacity, also often referred to as water retention capacity, of more than 30, as measured by diluting MFC samples to a 0.3% solids content in water, and then centrifuging the samples at 1000 G for 15 minutes, after which a clear water phase is separated from sediment and the sediment is weighed, wherein the water holding capacity is given as (mV/mT)⁻¹ wherein mV is weight of the wet sediment and mT is weight of dry WC analyzed.

8. The process according to claim 1, wherein the microfibrillated cellulose is non-modified (native) microfibrillated cellulose.

9. The process according to claim 1, wherein the at least partly chemically treated paper has been or is subjected to impregnation or surface coating or treatment, surface or internal sizing, wet-end treatment, dry-end treatment, size or film pressing, or any combination thereof, with at least one chemical composition that may comprise water, or any other solvent, but that comprises at least one compound other than water or solvent.

10. The process according to claim 9, wherein the at least one chemical composition is or comprises at least one of the following: means to control the pH, means to improve retention, means to fixate additives onto fibers, means to control penetration of liquids, means to improve burst and tensile strength, means to improve acid wet strength, means to improve optical and printing properties, means to improve or adjust a desired color, means to improve drainage and sheet formation, means to improve water retention or water removal, means to improve (optical) brightness, means to prevent deposition, means to control or inhibit growth or organisms, means to control corrosion, means to affect surface tension (contact angle), (mineral) fillers, in particular kaolin, calcium carbonate, silicates, titanium dioxide, dyestuffs.

11. The process according to claim 9, wherein the at least one chemical composition is or comprises at least one of the following: pigments, (mineral) fillers, polyvalent cations natural or chemically modified starches (cationic starches, anionic starches, oxidized starches, dextrin), natural gums or chemically modified gums, cellulose derivatives, native or chemically or physically modified microfibrillated cellulose, microcrystalline cellulose, synthetic polymers, in particular phenols, alcohols, acetates, polyamines, polyacrylamides, polyacrylic acids and compounds, polyacylic compounds, formaldehyde containing resins or polymers, polyamides, latices, or naturally occurring polymers.

12. The process according to claim 9, wherein the at least one chemical composition is or comprises at least one of the following: means to improve dry strength, dry strength resins, anionic or cationic copolymers of acrylamide, acrylamide polymers, including amphoteric products (with both anionic and cationic groups), linear and branched, low or high molecular weight polyacrylamides, synthetic dry-strength agents, synthetic dry-strength agents with molecular mass values below one million grams per mole, starch, starch derivatives or cationic starch, native or chemically or physically modified microfibrillated cellulose, microcrystalline cellulose, derivatives of natural products including carboxymethyl cellulose and guar gum derivative, pigments, calcium carbonate, titanium dioxide or plastic pigments, dispersants, lignins or lignin derivatives, or silicates, binders and polymer emulsions (latexes, acrylics, polyvinyl acetate), insolubilizers, glyoxal and latices, plasticizers, wax emulsions and azite, rheology control agents, cellulose derivatives and synthetic polymers, preservatives, defoamers (proprietary agents) and dyes, direct or acid dyes.

13. The process according to claim 9, wherein the at least one compound other than water or solvent is a polymer composition.

14. The process according to claim 1, wherein the at least partly chemically treated paper is characterized by a surface roughness, as measured according to the ISO 8791-2: 2013 (Bendtsen air flow method), wherein said surface roughness is below 1000 ml/min, as measured in accordance with ISO 8791-2:2013.

15. The process according to claim 1, wherein the chemically treated paper is characterized by an air resistance, as measured according to the ISO 5636-5, i.e. the Gurley method, wherein said air resistance is above 20 sec/100 ml.

16. The process according to claim 1, wherein the weight of the paper used as a liner is from 25 to 600 g/m² and/or the weight of the paper used as a flute is from 25 to 500 g/m².

17. Corrugated paperboards or cardboards having at least one flute and at least one liner, wherein at least one of these, or both has been/have been at least partly chemically treated, said paperboards or cardboards formed by a process according to claim 1.

18. The process according to claim 1, wherein the fluting paper is reinforced or strengthened recycled or recirculated paper and/or wherein the fluting paper is recycled paper characterized by a high air resistance, as measured according to the ISO 5636-5 (Gurley method), wherein said air resistance in the paper is above 20 sec/100 ml.

19. A process for making corrugated paperboards or cardboards, the process comprising forming the corrugated paperboards or cardboards using an adhesive composition comprising microfibrillated cellulose in an amount of 0.001% w/w to 10% w/w, dry matter, of the adhesive composition overall and fluting paper and liner paper, wherein at least one of fluting paper or liner paper, or both, has/have been or is/are chemically treated.

20. The process according to claim 1, wherein the amount of microfibrillated cellulose in the adhesive composition is from 0.01% w/w, relative to the overall weight of the composition to 0.5% w/w.
